(19) United States
(12) Patent Application Publication
(10) Pub. No.: US 2017/0045438 A1
(43) Pub. Date: Feb. 16, 2017

(54) High-Throughput Fluid Sample Characterization

(71) Applicant: MALVERN INSTRUMENTS LIMITED, Worcestershire (GB)

(72) Inventors: Alon Vaisman, Billerica, MA (US); John McCaffrey, Columbia, MD (US); Peter Bennet, Columbia, MD (US); Vishal Patil, Columbia, MD (US)

(21) Appl. No.: 15/305,327

(22) PCT Filed: Apr. 17, 2015
(86) PCT No.: PCT/GB2015/051167

§ 371 Date: Oct. 19, 2016

Related U.S. Application Data
(60) Provisional application No. 61/982,810, filed on Apr. 22, 2014.

(51) Int. Cl. G01N 15/14; G01N 21/53; G01N 15/08

(52) U.S. Cl. CPC G01N 15/1459; G01N 15/0806; G01N 21/53; G01N 2015/084; G01N 2201/06113

(57) ABSTRACT

A particle characterization apparatus and corresponding method is disclosed. The apparatus comprises a sample cell (14). The sample cell includes: an input opening (26) for receiving a fluid that carries particles flowing along a flow axis, a central acquisition channel (32) hydraulically responsive to the input opening (26) for receiving a first subset of the fluid, a pair of lateral bypass channels (32, 34) hydraulically responsive to the input opening (26) and disposed on either side of the central acquisition channel (32) for receiving second and third subsets of the fluid, a window (36) in the central acquisition channel (32) for illuminating the first subset of the fluid in the central acquisition channel (32),an illumination source (18) positioned to illuminate the fluid in the central acquisition channel (32) through the window (36), and a detector (20) positioned to receive light from the fluid in the central acquisition channel (32) after it has interacted with the fluid.

### CROSS-REFERENCE TO RELATED APPLICATION

This application is related to U.S. provisional application No. 61/942,027 filed on Feb. 20, 2014, to United States published application number 2014/0002662 published Jan. 2, 2014, and to PCT published application number WO/2013/190326, which are all herein incorporated by reference.

### FIELD OF THE INVENTION

This invention relates to methods and apparatus for detecting properties of heterogeneous samples, including detecting properties of particles, such as fluid droplets in industrial processes.

### BACKGROUND OF THE INVENTION

Laser diffraction and other methods are used to characterize samples in which a liquid carries suspended particles, which may be solid or liquid. To achieve higher throughput, prior art systems have diverted part of the flow through a side conduit to test a fraction of the flow.

### SUMMARY OF THE INVENTION

Several aspects of the invention are presented below and in the appended claims. Systems according to the invention can allow laser diffraction and other methods to accurately characterize particles suspended in liquids at high rates of flow with little or no effect on the very particles that the system seeks to measure. This contrasts with some prior art systems that divert part of the sample to a side channel and in the process can break up particles or create a flow pattern that tends to favor the diversion of some particles relative to others at higher flow rates.

According to an aspect, a particle characterization method is disclosed, comprising:
receiving a fluid that carries particles flowing along a flow axis,
receiving a first subset of the fluid in a central acquisition channel,
receiving second and third subsets of the fluid in a pair of lateral bypass channels disposed on either side of the central imaging channel,
illuminating the first subset of the fluid along an optical axis through a window acquiring radiation from the sample resulting from interaction of the radiation beam with the sample, and
deriving information about the particles from the radiation acquired in the step of acquiring.

The particles may be liquid droplets (or solid particles).

The flow within the central acquisition channel may be termed the acquisition flow.

The flow within the pair of bypass channels may be termed the bypass flow.

The central acquisition channel may increase in width and decrease in depth along the flow axis perpendicular to the optical axis before the central acquisition channel reaches the window.

The steps of receiving (i.e. any of the steps of receiving, some of the steps of receiving, or all of the steps of receiving) may slow the overall flow of the received acquisition and bypass flows by presenting a larger overall cross section upstream of the window.

The steps of receiving may employ a succession of channel cross-sections that are optimized to minimize shear stresses on the acquisition and bypass flows. For instance, a succession of acquisition channel cross-sections may be employed in the step of receiving the first subset of the fluid in the acquisition channel that are optimized to minimize shear stresses on the acquisition flow.

The central acquisition channel may decrease in width and increase in depth along the flow axis perpendicular to the optical axis after it reaches the window.

The rate of increase in the depth and decrease of the width may differ in a manner that minimizes shear forces on the particles as they pass through the central acquisition channel.

The step of receiving the fluid may include receiving the fluid through a cylindrical conduit. The method may further include the step of returning the fluid to another cylindrical conduit after the steps of illuminating and acquiring.

The step of receiving the fluid may include receiving the fluid through a conduit having a diameter of at least about 6.35 mm (0.25 inches) or at least about 12.7 mm (0.5 inches).

The step of receiving the fluid may include receiving the fluid at a flow rate of at least about: 3 liters per minute, 10 liters per minute, or 25 liters per minute.

The step of illuminating may be performed by a laser and the step of acquiring may acquire scattered radiation.

The aggregate flow capacity of the lateral bypass channels may exceed that of the central acquisition channel by at least a factor of about 10 at the window.

The flow capacity may be defined as an amount of flow through the respective channel for a specific pressure drop over the length of the channel. The flow capacity may alternatively be defined as the average cross sectional area.

The step of receiving a fluid includes receiving droplets of a first liquid suspended in a second liquid.

The step of receiving a fluid may include receiving droplets of water suspended in a hydrocarbon.

The step of receiving a fluid may include receiving droplets of water suspended in diesel fuel.

The central acquisition channel may comprise a a depth of: less than 1 mm, less than 4 mm, or about 0.5 mm.

The steps of receiving a first subset of the fluid in a central acquisition channel and receiving second and third subsets of the fluid in a pair of lateral bypass channels disposed on either side of the central acquisition channel may take place in an overall width of about 200 mm (8 inches).

According to another aspect, there is provided a particle characterization apparatus, comprising:
a sample cell that includes:
an input opening for receiving a fluid that carries particles flowing along a flow axis,
a central acquisition channel hydraulically responsive to the input channel for receiving a first subset of the fluid,
a pair of lateral bypass channels hydraulically responsive to the input channel and disposed on either side of the central acquisition channel for receiving second and third subsets of the fluid,
a window in the central acquisition channel for illuminating the first subset of the fluid in the central acquisition channel,
an illumination source positioned to illuminate the fluid in the central acquisition channel through the window, and
a detector positioned to receive light from the fluid in the central acquisition channel after it has interacted with the fluid.

The central acquisition channel may increase in width and decrease in depth along the flow axis perpendicular to the optical axis before it reaches (i.e. upstream of) the window.

The cell may slow the overall flow of the received acquisition and bypass flows by presenting a larger overall cross section upstream of the window.

The cell may employ a succession of channel cross-sections that are optimized to minimize shear stresses on the acquisition and bypass flows.

The central acquisition channel may decrease in width and increase in depth along the flow axis perpendicular to the optical axis after it reaches (i.e. downstream of) the window.

The rate of increase and decrease of the width may differ in a manner that minimizes shear forces on the particles as they pass through the central acquisition channel.

The input opening may receive the fluid through a cylindrical conduit.

The apparatus may further include an output opening that returns the fluid to another cylindrical conduit.

The input opening may have a diameter of at least about 0.25 inches or at least about 0.5 inches.

The cell may be designed to receive the fluid at a flow rate of at least about: 3 liters per minute, or 10 liters per minute.

The illumination source may include a laser and the detector may include a scattering detector.

The aggregate flow capacity of the lateral bypass channels may exceed that of the central acquisition channel by at least a factor of about 10 at the window.

The central acquisition channel may comprise a depth of: less than 1 mm, less than 4 mm, or less than 0.5 mm.

The cell may have an overall width of about 200 mm (8 inches).

The cell may further include another window in the central acquisition channel to pass light to the detector from the fluid in the central acquisition channel after it has interacted with the fluid.

According to another aspect, there is provided a particle characterization apparatus, comprising:
means for receiving a fluid that carries particles flowing along a flow axis,
means for receiving a first subset of the fluid in an acquisition channel,
means for receiving second and third subsets of the fluid in a pair of bypass
means for illuminating the first subset of the fluid,
means for acquiring radiation from the sample resulting from interaction of the radiation beam with the sample, and
means for deriving information about the particles from the radiation acquired by the means for acquiring.

### BRIEF DESCRIPTION OF THE DRAWINGS

FIG. 1 is a block diagram of a particle characterization system according to the invention,

FIG. 2 is a first cross-sectional diagram of a high-throughput sample cell for the system of FIG. 1, cut as shown by line 2-2 in FIG. 3;

FIG. 3 is a second cross-sectional diagram of the sample cell of FIG. 2, cut as shown by line 3-3 in FIG. 2;

FIG. 4 is a third cross-sectional diagram of the sample cell of FIG. 2, cut as shown by lines 4-4 in FIGS. 2 and 3; and

FIG. 5 is a plot of the cross-sectional area of the detection cell of FIG. 2 along its flow direction.

### DETAILED DESCRIPTION OF AN ILLUSTRATIVE EMBODIMENT

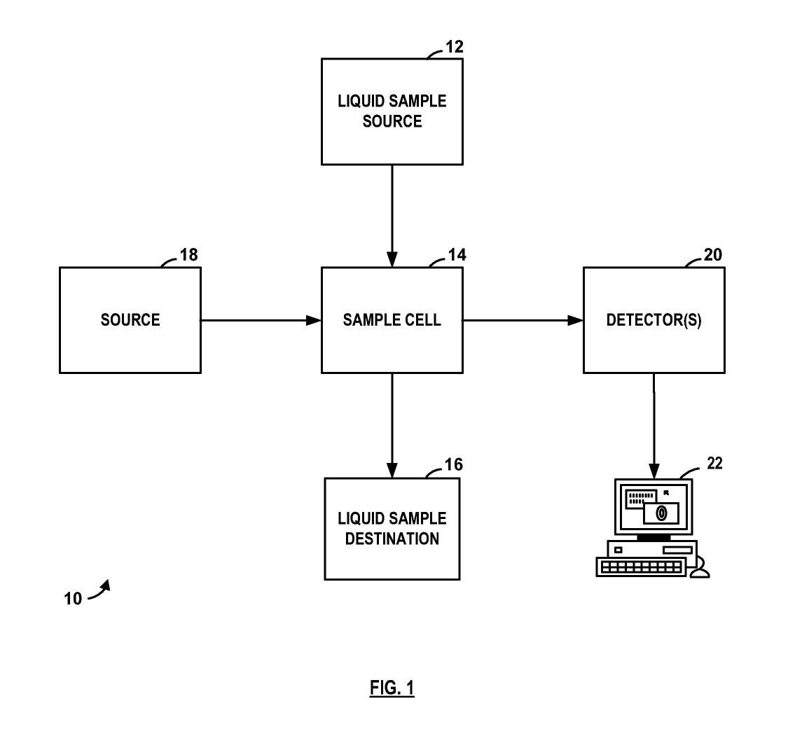

Referring to FIG. 1, a particle characterization system 10 according to the invention characterizes a sample that includes particles suspended in a liquid received from a liquid sample source 12, and passes it along to its destination 16, which may be a downstream processing station in an industrial process. The system includes a sample cell 14 that is hydraulically connected between the liquid sample source and the liquid sample destination. It also includes at least one radiation source 18, such as a laser, which irradiates the sample cell, such as through a window, and one or more detectors 20, which detect radiation that has interacted with the sample. An analysis and/or control system 22 is responsive to the detectors and can receive, record, and analyze signals from the detectors to such as to derive size values from the detector signals. It

In one embodiment, the system performs laser diffraction measurements on diesel fuel to characterize water droplets suspended in the fuel, although other types of optical point, line, or image-based measurements can also be performed on other kinds of samples. In this embodiment, the source is a laser and the detectors include a number of scattering detectors disposed at different positions opposite the laser with respect to the sample cell. The system can employ an off-the-shelf spray characterization system, such as the Insitec Wet system available from Malvern, Inc., to measure the ensemble average particle size within the sample.

The analysis and/or control system 22 can include special-purpose software programs running on a general-purpose computer platform in which stored program instructions are executed on a processor, but it could also be implemented in whole or in part using special-purpose hardware.

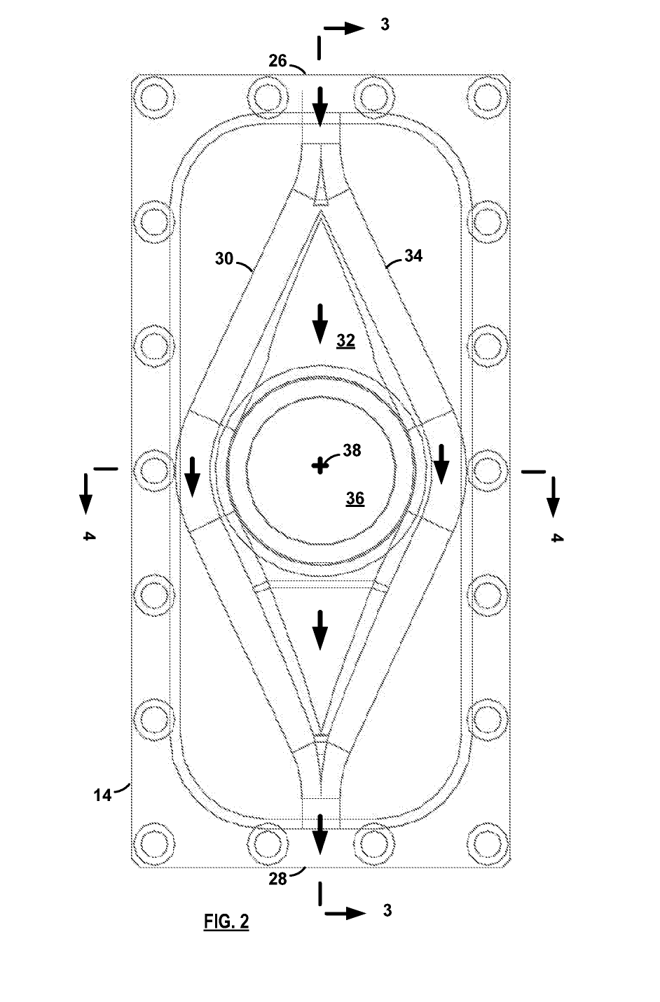

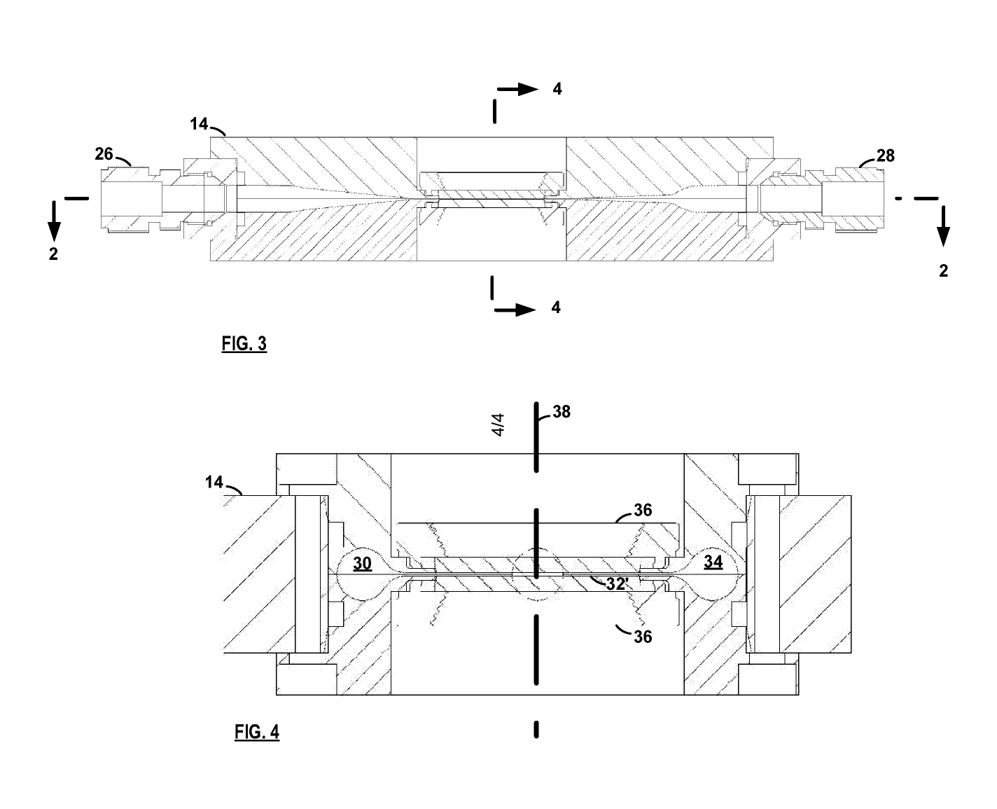

Referring to FIGS. 2-4, the sample cell 14 includes an input opening 26 that receives the liquid sample. Downstream from the input opening, the cell opens up and gradually diverges into three channels: a left bypass channel 30, a central imaging or acquisition channel 32, and a right bypass channel 34. The central imaging channel passes straight through the cell and becomes both wider and shallower until it reaches an imaging (or acquisition) chamber 32′ between two windows 36. The bypass channels gently diverge to the sides of the cell and also increase somewhat in diameter over the same distance. After the imaging chamber, the channels generally follow a mirror image of their path into the chamber, ending at an output opening 28.

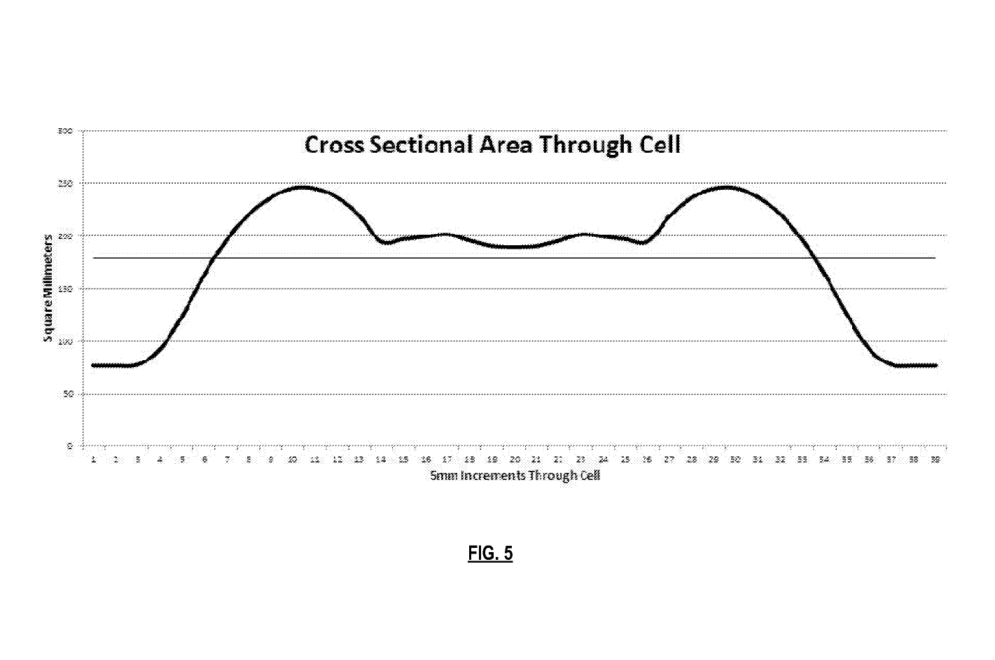

Referring also to FIG. 5, the aggregate cross-sectional area of the inside flow volume of the cell is initially that of a standard 0.5 inch conduit. It then increases steadily as the measurement and bypass and channels spread the flow. As the flow reaches the measurement chamber, the cross-sectional area decreases and then remains generally stable over the span of the measurement chamber. The flow then increases and decreases again after the chamber according to a profile that is generally a mirror image of the incoming increase and decrease.

The profile was designed to slow the sample and gently split it into the three channels simulating the flow and iteratively adjusting the profile until the simulated shear stresses were below an acceptable level. In this embodiment, the Ansys CFX software package available from Ansys Inc. was used to model the flow during the design process. Note that minimizing shear stresses results in a design in which the incoming geometry is not exactly symmetrical with respect to the outgoing geometry. An implementation of the sample cell has been built using a clam-shell design with two numerically machined halves that are bolted together, although other designs could also be implemented.

The central imaging channel is preferably centered around an optical axis 38 along which the sample is irradiated. The imaging axis is also preferably located at the center of the cell perpendicular to its flow direction. Other optical arrangements are also possible, such as embodiments in which the optical axis passes through the windows at an angle or in which the optical axis is located upstream or downstream from the center of the cell.

The above-described system was designed and simulated in an application to test diesel fuel against ISO16332, which is a standard method for evaluating the fuel/water separation efficiency of diesel engine filters. The cell was designed to operate between 3 and 28 LPM and was capable of measuring water droplets between 5-200 μm in diameter in fuel. The results of running an SST (Shear Stress Transport) model to simulate turbulent flow and TAB (Taylor analogy breakup) model to predict breakup of a 200 μm water droplet with a surface tension of 10 mN/m at a flow rate of 28 LPM demonstrated good performance with no significant particle breakup of the 200 μm droplets.

The present invention has now been described in connection with a number of specific embodiments thereof. However, numerous modifications which are contemplated as falling within the scope of the present invention should now be apparent to those skilled in the art. For example, while the particles are described as being liquid droplets in the embodiments shown, they can also be solid or gaseous. More comprehensively, systems according to the invention are applicable to heterogeneous fluid samples that include a continuous liquid or gas phase and a discontinuous phase that can include either a liquid, solid, or gas. It is therefore intended that the scope of addition, the order of presentation of the claims should not be construed to limit the scope of any particular term in the claims.

1. A particle characterization method, comprising:
receiving a fluid that carries particles flowing along a flow axis,
receiving a first subset of the fluid in a central acquisition channel,
receiving second and third subsets of the fluid in a pair of lateral bypass channels disposed on either side of the central imaging channel,
illuminating the first subset of the fluid along an optical axis through a window in the central imaging channel with a radiation beam,
acquiring radiation from the sample resulting from interaction of the radiation beam with the sample, and
deriving information about the particles from the radiation acquired in the step of acquiring.

2. The method of claim 1, wherein the particles are liquid droplets.

3. The method of claim 1 or 2 wherein the central acquisition channel increases in width and decreases in depth along the flow axis perpendicular to the optical axis before the central acquisition channel reaches the window.

4. The method of claim 3 wherein the steps of receiving slow the overall flow of the received acquisition and bypass flows by presenting a larger overall cross section upstream of the window.

5. The method of any of claims 2 to 4 wherein the steps of receiving employ a succession of channel cross-sections that are optimized to minimize shear stresses on the acquisition and bypass flows.

6. The method of any of claims 2 to 5 wherein the central acquisition channel decreases in width and increases in depth along the flow axis perpendicular to the optical axis after it reaches the window.

7. The method of claim 6 wherein the rate of increase in the depth and decrease of the width differ in a manner that minimizes shear forces on the particles as they

8. The method of claim 1 wherein the step of receiving the fluid includes receiving the fluid through a cylindrical conduit.

9. The method of claim 8 further including the step of returning the fluid to another cylindrical conduit after the steps of illuminating and acquiring.

10. The method of any preceding claim wherein the step of receiving the fluid includes receiving the fluid through a conduit having a diameter of at least about 6.35 mm (0.25 inches) or 12.7 mm (0.5 inches).

11. The method of any preceding claim wherein the step of receiving the fluid includes receiving the fluid at a flow rate of at least about: 3 liters per minute, 10 liters per minute, or 25 liters per minute.

12. The method of any preceding claim wherein the step of illuminating is performed by a laser and wherein the step of acquiring acquires scattered radiation.

13. The method of any preceding claim wherein the aggregate flow capacity of the lateral bypass channels exceeds that of the central acquisition channel by at least a factor of about 10 at the window.

14. The method of any preceding claim wherein the particles are droplets of a first liquid suspended in a second liquid.

15. The method of any preceding claim wherein the particles are droplets of water suspended in a hydrocarbon.

16. The method of any preceding claim wherein the particles are droplets of water suspended in diesel fuel.

17. The method of any preceding claim wherein the central acquisition channel comprises a depth of: less than 1 mm, less than 4 mm, or about 0.5 mm.

18. The method of any preceding claim wherein the steps of receiving a first subset of the fluid in a central acquisition channel and receiving second and third subsets of the fluid in a pair of lateral bypass channels disposed on either side of the central acquisition channel take place in an overall width of about 200 mm (8 inches).

19. A particle characterization apparatus, comprising:
a sample cell that includes:
an input opening for receiving a fluid that carries particles flowing along a flow axis,
a central acquisition channel hydraulically responsive to the input opening for receiving a first subset of the fluid,
a pair of lateral bypass channels hydraulically responsive to the input opening and disposed on either side of the central acquisition channel for receiving second and third subsets of the fluid,
a window in the central acquisition channel for illuminating the first subset of the fluid in the central acquisition channel,
an illumination source positioned to illuminate the fluid in the central acquisition channel through the window, and
a detector positioned to receive light from the fluid in the central acquisition channel after it has interacted with the fluid.

20. The apparatus of claim 19 wherein the central acquisition channel increases in width and decreases in depth along the flow axis perpendicular to the optical axis before it reaches the window.

21. The apparatus of claim 20 wherein the cell slows the overall flow of the received acquisition and bypass flows by presenting a larger overall cross section upstream of the window.

22. The apparatus of claim 18 or 19 wherein the cell employs a succession of channel cross-sections that are optimized to minimize shear stresses on the acquisition and bypass flows.

23. The apparatus of any of claims 20 to 22 wherein the central acquisition channel decreases in width and increases in depth along the flow axis perpendicular to the optical axis after it reaches the window.

24. The apparatus of claim 23 wherein the rate of increase and decrease of the width differ in a manner that minimizes shear forces on the particles as they pass through the central acquisition channel.

25. The apparatus of any of claims 19 to 24 wherein the input opening receives the fluid through a cylindrical conduit.

26. The apparatus of claim 25 further including an output opening that returns the fluid to another cylindrical conduit.

27. The apparatus of any of claims 19 to 24 wherein the input opening has a diameter of at least about 0.25 inches or at least about 0.5 inches.

28. The apparatus of any of claims 19 to 27 wherein the cell is designed to receive the fluid at a flow rate of at least about: 3 liters per minute, or 10 liters per minute.

29. The apparatus of any of claims 19 to 28 wherein illumination source includes a laser and the detector includes a scattering detector.

30. The apparatus of any of claims 19 to 29 wherein the aggregate flow capacity of the lateral bypass channels exceeds that of the central acquisition charnel by at least a factor of about 10 at the window.

31. The apparatus of any of claims 19 to 30 wherein the central acquisition channel comprises a depth of: less than 1 mm, less than 4 mm, or less than 0.5 mm.

32. The apparatus of any of claims 19 to 31 wherein the cell has an overall width of about 200 mm (8 inches).

33. The apparatus of any of claims 19 to 32 wherein the cell further includes another window in the central acquisition channel to pass light to the detector from the fluid in the central acquisition channel after it has interacted with the fluid.

34. A particle characterization apparatus, comprising:
means for receiving a fluid that carries particles flowing along a flow axis,
means for receiving a first subset of the fluid in an acquisition channel,
means for receiving second and third subsets of the fluid in a pair of bypass channels,
means for illuminating the first subset of the fluid,
means for acquiring radiation from the sample resulting from interaction of the radiation beam with the sample, and
means for deriving information about the particles from the radiation acquired by the means for acquiring.
